(19) United States
(12) Patent Application Publication
(10) Pub. No.: US 2024/0426240 A1
(43) Pub. Date: Dec. 26, 2024

(54) FUEL COMBUSTOR, COMBUSTION TURBINE, AND METHOD OF COMBUSTION

(71) Applicants: Electric Power Research Institute, Inc., Palo Alto, CA (US); Georgia Tech Research Corporation, Atlanta, GA (US)

(72) Inventors: Timothy Charles Lieuwen, Atlanta, GA (US); Renee Katherine Cole, Allen, TX (US); Benjamin Lee Emerson, Peachtree City, GA (US); Srujan Harish Gubbi, Atlanta, GA (US); James Harper, Greenville, SC (US); David Robert Noble, Catawba, NC (US); Robert Charles Steele, Anderson Island, WA (US); Wenting Sun, Alpharetta, GA (US); David Jin-Wei Wu, Acworth, GA (US)

(21) Appl. No.: 18/753,526

(22) Filed: Jun. 25, 2024

Related U.S. Application Data
(60) Provisional application No. 63/523,108, filed on Jun. 25, 2023.

(51) Int. Cl. F02C 3/22; B01D 53/94; F23R 3/40

(52) U.S. Cl. CPC F02C 3/22; F23R 3/40; B01D 53/9409

(57) ABSTRACT

A fuel combustor for nitrogen-containing fuel minimizes NOx emissions from the combustion of nitrogen-containing fuels such as ammonia fuel. A turbine for generating power includes a drivable turbine and at least one of the fuel combustors for nitrogen-containing fuel. Methods of combusting nitrogen-containing fuel with the fuel combustor, minimizing NOx emissions formed by the combustion of nitrogen-containing fuel, and generating power are disclosed.

This application claims the benefit of the filing date under 35 U.S.C. 119 (e) from United States Provisional Application For Patent Ser. No. 63/523,108, filed Jun. 25, 2023, which is hereby incorporated by reference in its entirety.

### STATEMENT REGARDING FEDERALLY SPONSORED RESEARCH

This invention was made with government support awarded by the United States Department of Energy under Contract Nos. DE-FE0032079 and DE-FE0032172. The government has certain rights in the invention.

### TECHNICAL FIELD

The present disclosure relates to a fuel combustor, a combustion turbine, and a method of combusting fuel using the fuel combustor. The present disclosure more particularly relates to a fuel combustor for combusting a nitrogen-containing fuel, a combustion turbine including the fuel combustor for combusting a nitrogen-containing fuel, a method for combusting a nitrogen-containing fuel, and a method of power generation using the fuel combustor and combustion turbine.

### BACKGROUND

Ammonia fuel does not contain carbon and is attractive as a possible decarbonization fuel. Ammonia is also more readily manufactured and transported as compared to other potential decarbonization fuels. Ammonia fuel combustion therefore offers a solution for decarbonized power generation.

Ammonia can be used directly in combustion applications or decomposed (eg, cracked) back to a H2/N2 blend (ie, “forming gas”). While direct application of ammonia has a number of cost and efficiency benefits, the presence of fuel-bound nitrogen can potentially lead to significantly more NOx emissions during ammonia fuel combustion than if it is reacted as H2/N2. Measured emission values show that NOx emissions from ammonia combustion are one to two order of magnitudes higher than current industry benchmarks for natural gas combustion or existing EPA regulation (0.15 lbs/mm Btu; 64.5 ng/J).

Ammonia also exhibits challenging combustion characteristics such as limited flammability range, lower flame temperature, and slower laminar flame speeds as compared to traditional hydrocarbon fuels. These combustion characteristics and increased NOx emissions attributed to molecularly-bound nitrogen pose a significant challenge to the viability of ammonia fuels as a decarbonization fuel.

Certain conventional combustion systems use “non-premixed burners”, where gaseous or liquid fuel and air are introduced separately into the combustor, where they are mixed together and then combusted. Generally, a fraction of the combustion air enters the front-end primary combustion zone of the combustor with the remainder of the combustion air entering the system at a downstream location.

Flames produced by non-premixed combustors lead to elevated NOx levels and, if the fuel contains carbon, to soot production. For this reason, many modern burner combustor designs, use lean-premixed approaches, where the majority of the combustion air is mixed with the fuel at the front end of the system prior to entering the primary combustion zone of the combustor. The lean-premixed systems minimize the temperature overshoot in the primary combustion zone encountered in non-premixed combustors and, consequently, form less NOx during combustion. Such lean-premixed systems are effective for NOx control when burning fuels without molecularly bound nitrogen, such as hydrogen, natural gas, or propane. However, lean premixed systems for ammonia fuel combustion results in up to two orders of magnitude higher NOx emissions as compared to non-nitrogen containing fuels. The term “lean” herein refers to fuel/air ratios where excess air is present and the mixture is “fuel-lean”. Conversely, the term “rich” refers to fuel/air ratios where excess fuel is present.

Staged combustion systems with multiple exothermic combustion zones deliberately employed in the design are commonly used for reducing NOx emissions and have been used in applications where gas turbine inlet temperatures or overall device temperatures exceed values where significant NOx formation occurs. In systems utilizing fuels without molecularly bound nitrogen (such as hydrogen or natural gas), a lean premixed primary combustion zone is followed by a secondary fuel stage (e.g., an “axial fuel stage”). In these staged systems, the majority of the fuel is burned in the lean premixed mode in the primary combustion zone at a low temperature to avoid significant NOx formation. If the desired combustor exit temperature is high enough to lead to undesired NOx formation, then remaining fuel is added in a second lean stage with mixing and combustion in order to minimize residence times at high temperature conditions, while still consuming all the fuel.

Another staged combustion approach includes a fuel-rich primary combustion stage and a fuel-lean stage and is commonly referred to as a rich-quench-lean combustor, or “RQL” combustor. The subsequent fuel lean stage aims to mix combustion air and rich combustion products rapidly in an overall-lean stoichiometry to minimize NOx formation in the lean stage and to consume any particulates that might be formed in the primary rich combustion zone. NOx emissions from RQL combustors can still be quite high and there is undesired H2 emissions associated with RQL combustors.

Additionally, combustors with water injection may potentially reduce NOx formation during combustion. However, combustors with water injection require a complicated water skid and water supply. Water injection is typically used on non-premixed systems as its effect is greatest on reactions which occur at stoichiometric conditions. Premixed systems, which start from lower emissions see less impact on NOx emissions. Fuel bound nitrogen based NOx emissions are also less sensitive to water injection. It can also be expected the entitlement of NOx reduction with water or steam injection would be less than 1 order of magnitude. At this highest NOx reduction there are also high thermal gradient potential on the combustion system which can lead to reduced life. Water injection requirements at this level can also be twice as high as fuel demand in mass flow rates requiring very high water flows. All these issues make such systems undesirable for use with decarbonization combustion fuels based on nitrogen-containing fuels.

### SUMMARY OF ILLUSTRATIVE EMBODIMENTS

According to a first illustrative embodiment, provided is a combustor for a nitrogen-containing fuel comprising:
a fuel rich combustion zone,
a relaxation zone downstream from the fuel rich combustion zone,
a quench zone downstream from the relaxation zone, and
a fuel lean combustion zone downstream from the quench zone.

According to a second illustrative embodiment, provided is a combustion turbine comprising:
a turbine,
a compressor, and
at least one fuel combustor for a nitrogen-containing fuel comprising:
   a fuel rich combustion zone,
   a relaxation zone downstream from the fuel rich combustion zone,
   a quench zone downstream from the relaxation zone, and
   a fuel lean combustion zone located downstream from the quench zone.

According to a third illustrative embodiment, provided is a method for combusting a nitrogen-containing fuel comprising:
delivering a nitrogen-containing fuel to a rich fuel combustion zone of a fuel combustor;
at least partially combusting the nitrogen-containing fuel in a rich fuel combustion stage in the rich fuel combustion zone of the combustor to form rich fuel combustion product mixture, wherein the rich fuel combustion product mixture comprises NO at levels above equilibrium levels;
permitting to NO levels formed during the rich fuel combustion stage in the rich fuel combustion zone of the combustor to relax toward an equilibrium level during a relaxation stage in a relaxation zone of the fuel combustor;
following the relaxation stage, delivering additional combustion air to the combustion product mixture with relaxed NO levels in a quench zone of the fuel combustor;
delivering the mixture of the rich fuel combustion product mixture with relaxed NO levels and additional combustion air to a lean fuel combustion zone; and
further combusting the combustion product mixture in a lean fuel combustion stage in the lean fuel combustion zone.

According to a fourth illustrative embodiment, provided is a method of power generation with a combustion turbine comprising a turbine, compressor, and at least one fuel combustor configured to combust nitrogen-containing fuel, the fuel combustor comprising a fuel rich combustion zone, a relaxation zone downstream from the fuel rich combustion zone, a quench zone downstream from the relaxation zone, and a fuel lean combustion zone located downstream from the quench zone, the method comprising combusting a nitrogen-containing fuel with the fuel combustor to create an exhaust gas and driving the turbine with the exhaust gas.

According to a fifth illustrative embodiment, disclosed is the use of a relaxation zone in a nitrogen-containing fuel combustor used in a method for a combusting nitrogen-containing fuel to permit high NO levels formed in a rich fuel combustion zone of the combustor to relax toward lower equilibrium levels.

According to a sixth illustrative embodiment, disclosed is the use of a relaxation zone in a nitrogen-containing fuel combustor used in a method for power generation using nitrogen-containing fuels to permit high NO levels formed in a rich fuel combustion zone of the combustor to relax toward lower equilibrium levels.

### BRIEF DESCRIPTION OF THE DRAWINGS

FIG. 1 is a perspective view of an illustrative embodiment of the fuel combustor of the present disclosure showing the rich fuel primary combustion stage, relaxation stage, quench stage, and secondary lean fuel combustion stage.

FIG. 2A is a side view of an illustrative embodiment of the fuel combustor of the present disclosure showing the rich fuel primary combustion stage, relaxation stage, quench stage, and secondary lean fuel combustion stage.

FIG. 2B is a cross sectional view of an illustrative embodiment of the fuel combustor of the present disclosure showing the rich fuel primary combustion stage, relaxation stage, quench stage, and secondary lean fuel combustion stage.

FIG. 3 is a cross sectional view of an illustrative embodiment of the fuel combustor of the present disclosure showing the rich fuel primary combustion stage, relaxation stage, quench stage, and secondary lean fuel combustion stage showing flow trajectories with superimposed temperature profiles obtained from computations from a notional combustor.

FIG. 4 is a side view of another illustrative embodiment of the fuel combustor of the present disclosure showing the rich fuel primary combustion stage, relaxation stage, quench stage, and secondary lean fuel combustion stage.

FIG. 5 is a graph depicting the dependence of equilibrium NO emissions from ammonia fuel combustion as a function of equivalence ratio and pressure. 1 bar, 5 bar, 10 bar, 15 bar and 20 bar).

FIG. 6 is a graph depicting the formation of NO emissions of the present (“RRQL”) combustor design compared to known lean premixed (“LP”) and rich-quench-lean (“RQL”) designs at a pressure of 10 bar and a fuel combustor exit temperature of 1900K.

FIG. 7 is a graph depicting illustrative residence time of the relaxation stage of the fuel combustor and fuel combustion method required for NO levels to relax to within 5% of its equilibrium as a function of pressure at a combustor exit temperature of 1900K.

FIG. 8 is a graph depicting experimental data of NOx relaxation as a function of residence time of the relaxation stage of a rich, swirled, atmospheric, ammonia-air flame with a combustor exit temperature of 1945K, or an equivalence ratio (ϕ) of 1.2, and no preheat. Equilibrium NOx is also calculated and plotted.

### DETAILED DESCRIPTION OF ILLUSTRATIVE EMBODIMENTS

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of recited value, or defined to be within 10% of recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 100” is to be read as indicating each and every possible number along the continuum between about 1 and about 100. It is to be understood that the inventors appreciate and understand that any and all data points within the range are to be considered to have been specified, and that the inventors have possession of the entire range and all points within the range.

It should be understood that when a concentration in ppm is described in the present disclosure, it is intended that any and every amount within the range, including the end points, is to be considered as having been expressly disclosed. For example, the disclosure of “a range of from about 1 to about 100” is to be read as indicating each and every possible number along the continuum between about 1 and about 100. It is to be understood that the inventors appreciate and understand that any and all data points within the range are to be considered to have been specified, and that the inventors have possession of the entire range and all points within the range.

For the avoidance of doubt, alternative and optional features indicated for a given aspect, component, feature, or parameter of the invention should, unless the context indicates otherwise, be regarded as having been disclosed in combination with any and all other alternative or optional features and the like as indicated for the same or other aspects, features and parameters of the invention.

Disclosed is a fuel combustor, a combustion turbine, and a method of combustion designed to minimize the formation of NOx emissions from the combustion of nitrogen-containing fuels. For example, and without limitation, the fuel combustor, combustion turbine including the combustor, and the method of combustion are designed to minimize or otherwise reduce the formation of NOx emissions from combustion of nitrogen-containing fuels, such as, without limitation, direct ammonia fuel, partially cracked ammonia (i.e., NH3/N2/H2 blends), or blends of ammonia with other fuels. According to certain embodiments, the fuel combustor, combustion turbine including the combustor, and the method of combustion are designed to minimize or otherwise reduce the formation of NOx emissions from ammonia fuel-air combustion.

The presently disclosed fuel combustor may be referred to as a “rich-relaxation-quench-lean” combustor, or “RRQL” combustor. The term “combustor” and “RRQL combustor” may be used interchangeably in the present specification and claims.

There are three main types of air-fuel mixtures commonly referred to in the combustion art, “lean fuel mixtures”, “stoichiometric fuel mixtures” and “rich fuel mixtures”. Stoichiometric fuel mixture is an air-fuel mixture that contains the exact amount of air required to burn all the fuel in the mixture. A lean fuel mixture has more combustion air than the required quantity of air for the complete combustion of the nitrogen-containing fuel in the mixture. A rich fuel mixture has less combustion air than the required quantity of air for the complete combustion of the nitrogen-containing fuel in the mixture.

The RRQL combustor comprises multiple combustion stages. According to certain embodiments, the RRQL combustor comprises a primary rich fuel combustion stage and a secondary fuel lean combustion stage that is located downstream from the primary rich fuel combustion stage. A relaxation stage is located between the primary rich fuel combustion stage and the downstream secondary lean fuel combustion stage to enable peak levels of NO formed during the rich fuel primary combustion stage of the combustion process to relax or otherwise approach or return to lower equilibrium levels in the relaxation stage. Simply combusting an ammonia fuel with a rich combustion zone, followed by a lean combustion zone (e.g., a conventional RQL combustor) will not necessarily result in low NOx levels. The relaxation zone described herein enables super-equilibrium NOx levels formed in the rich stage to drop down towards lower equilibrium levels. According to certain embodiments, the required relaxation length for this process is a function of pressure as described hereinafter.

According to certain illustrative embodiments, the RRQL combustor comprises an upstream rich fuel primary combustion zone, a relaxation zone located downstream from the rich fuel primary combustion zone, a quench zone located downstream from the relaxation zone, and a lean fuel combustion zone located downstream from the quench zone. These plurality of zones of the fuel combustor are in fluid communication with one another to permit the combustion products to flow from the upstream entry point of the rich fuel primary combustion zone to the exhaust exit of the downstream end of the secondary lean fuel combustion zone of the fuel combustor.

According to other embodiments, a combustion turbine is provided to generate power from a nitrogen-containing fuel source. The combustion turbine comprises at least one turbine, at least one compressor, and at least one RRQL combustor positioned upstream from the at least one turbine. The RRQL combustor of the combustion turbine comprises an upstream rich fuel primary combustion zone, a relaxation zone downstream from the rich fuel combustion zone, and a secondary fuel lean combustion zone downstream from the relaxation zone. According to certain embodiments, the RRQL combustor of the combustion turbine comprises an upstream rich fuel primary combustion zone, a relaxation zone downstream from the rich fuel primary combustion zone, a quench zone downstream from the relaxation zone, and a secondary fuel lean combustion zone downstream from the quench zone. While a combustion turbine is an illustrative embodiment, this RRQL combustor may be used in any system where fuel combustion is the energy input method.

Also disclosed is a method of combusting a nitrogen-containing fuel. The present method achieves low levels of NOx emissions that have not been previously attained in the art using non-premixed, lean premixed, or staged RQL combustors.

The method of combusting a nitrogen-containing combustion fuel comprises combusting a fuel rich mixture of nitrogen-containing fuel and combustion air in an upstream rich fuel primary combustion stage to form a mixture of primary combustion products and remaining uncombusted fuel in the form of H2 and N2, delivering the mixture formed from the rich fuel primary combustion stage to a relaxation stage where the NO formed during the rich fuel primary combustion stage relaxes or otherwise returns to equilibrium levels, and combusting the mixture in a fuel lean combustion stage under lean fuel combustion conditions.

According to certain embodiments, the method of combusting a nitrogen-containing combustion fuel comprises combusting a fuel rich mixture of nitrogen-containing fuel and combustion air in an upstream rich fuel primary combustion stage to form a mixture of primary combustion products and remaining uncombusted fuel in the form of H2 and N2, delivering the mixture formed from the rich fuel primary combustion stage to a relaxation stage where the NO formed during the rich fuel primary combustion stage relaxes or otherwise returns to equilibrium levels, subjecting the mixture to a quench stage, and combusting the mixture in a secondary lean fuel combustion stage. During the quench stage of the combustion, additional combustion air (also referred to as secondary combustion air) is introduced to the system prior to the secondary lean fuel combustion stage.

According to certain embodiments, the NO levels formed in the fuel rich primary combustion stage is in the range of 100's to 1000's of ppm. This range of NO levels may be referred to as the peak rich stage NO value.

According to certain embodiments, following the relaxation stage, the NO levels formed in the fuel rich primary combustion stage decrease to a level in the range of 70 ppm to about 1 ppm.

According to certain embodiments, the inclusion of the relaxation zone in the fuel combustor permits the NO levels formed from the combustion of ammonia fuel in the fuel-rich primary combustion stage of the fuel combustor to relax to a level within 25% of its equilibrium level, or within 20% of its equilibrium level, or within 15% of its equilibrium level, or within 10% of its equilibrium level, or within 5% of its equilibrium level, dropping from the peak value formed in the fuel rich primary combustion stage.

According to certain embodiments, the NO emissions levels following the relaxation and secondary lean fuel combustion stages is in the range of 150 ppm to about 5 ppm. It is believed that the range of NOx formed in the secondary lean fuel combustion stage is in the range of about 70 ppm to about 5 ppm. The total amount of NOx emissions from the exit of the lean fuel stage of the combustor includes the amount of NOx remaining after the relaxation stage plus the amount of NOx formed in the lean fuel combustion stage.

The combustor design and method of combusting nitrogen-containing fuel are enabled by the fact that equilibrium NO values are very low with rich ammonia combustion. However, known designs do not enable NO values to achieve these low equilibrium levels. The addition of an additional stage, the relaxation stage, between the “R” and the “Q” stages of an RQL combustor enables the NO formed during the rich fuel primary combustion stage to approach or return to low equilibrium levels.

This relaxation stage may comprise a long residence time of the primary rich fuel combustion product mixture (such as in conduit, pipe, or tube of sufficient length to enable longer residence time to permit NO levels to relax toward equilibrium levels), or may comprise a chemical reactor stage, or may comprise an internal flow recirculation, or may comprise the step of introducing additional chemicals or catalysts into the relaxation stage to accelerate NO relaxation toward equilibrium.

The relaxation stage may comprise a chemical reactor stage. Without limitation, and only by way of illustration, the relaxation stage comprising a chemical reactor comprises a catalytically enhanced chemical reactor stage where elevated NO levels formed during the rich fuel primary combustion of the ammonia relaxes toward equilibrium levels. The catalytically enhanced chemical reactor stage may comprise a catalytic channel.

According to certain embodiments, the chemical reactor comprising the relaxation stage of the combustor comprises a catalytically enhanced chemical reactor. The catalytically enhanced chemical reactor may comprise a honeycomb catalyst support, plate-type catalyst support, or corrugated-type catalyst support with catalyst carried by said support. Without limitation, and only by way of illustration, suitable catalysts may be selected from one or more of metal oxide-based, zeolite-based, alkaline-earth metal-based, and rare-earth-based catalysts. A suitable metal oxide catalyst comprises vanadium pentoxide (V₂O₅).

High NO levels are initially formed during combustion of ammonia fuel, but these NO levels relax toward equilibrium by reaction with the NH₂ radicals and NH produced in rich fuel flames, that subsequently react with NO and drive it toward its equilibrium value (which is very low). Current staged combustor designs do not enable this relaxation process, because it requires adding significant time/length to the combustor to enable this slow relaxation of NO levels to occur. Following exposure of the combustion product mixture formed in the rich fuel primary combustion stage to the NO relaxation stage, the rich fuel combustion product mixture with relaxed levels of NO and any remaining uncombusted N2/H2 can then be mixed with the additional combustion air and further combusted under fuel lean conditions. According to certain embodiments, the lean fuel combustion stage further minimizes NOx formation rates if the mixture of the additional combustion air and the rich fuel combustion product mixture is provided to the lean fuel combustion stage in a premixed condition.

The relaxation process of NO level toward equilibrium levels is slow and takes much longer residence times than is currently used in gas turbine combustors (where, for example, aviation systems use 5 ms and ground power systems use 10-20 ms residence times). As such, this RRQL combustor requires a dedicated additional stage to enable the relaxation of NO levels. A calculation of this approximate time required for this process is shown in FIG. 6. Experimental results illustrating the relaxation process over 150 ms is shown in FIG. 8. Shorter relaxation times are also possible, but will lead to higher NO emissions. Note that the pressure is a function of the device that the combustor is used in; for example, a residential water heater would run near atmospheric pressure, while an industrial gas turbine would be in the 10-25 bar range. The RRQL combustor design works with any of these devices or other combustion devices, with the requisite relaxation stage sizing controlled by the need for this relaxation process to reach desired NO levels relative to equilibrium. Similarly, the flow rate and reactant/fuel temperature would be controlled by the larger system within which the combustor is operated. This RRQL combustor design will work with any of these systems, with the relative combustor sizing controlled by flow rates and temperatures.

The combustor design described herein provides the ability to be retrofittable to many typical current configurations while also meeting the residence times required for NOx relaxation. The liner length and diameter may be maximized while still meeting size and interface constraints. A short nozzle premixing section allows for the longer liner length while reduced liner diameter in its aft section to allows mating with a first stage nozzle which also assists with the quench jet performance in combustion reaction quenching.

According to certain embodiments, the pressure of the rich fuel primary combustion stage is in the range of about 1 to about 40 bar, the temperature of the rich fuel primary combustion stage is in the range of about 1500 to about 2200 K, and the residence time of the rich fuel primary combustion stage is in the range of about 1 to about 5 ms.

According to certain embodiments, the residence time of the relaxation stage is about 20 to about 1000 ms.

According to certain embodiments, the pressure of the lean fuel secondary combustion stage is in the range of about 1 to about 40 bar, the temperature of the lean fuel secondary combustion stage is in the range of about 1500 to about 2050 K, and the residence time of the lean fuel secondary combustion stage is in the range of about 1 to about 20 ms.

According to another illustrative embodiment, the method for combusting a nitrogen-containing fuel comprises delivering a nitrogen-containing fuel to a rich fuel combustion zone of a fuel combustor. According to this embodiments, the nitrogen-containing fuel and air may be non-premixed, well mixed, or partially pre-mixed before any combustion process. This embodiment of the method involves combusting the nitrogen-containing fuel in a rich fuel combustion stage in the rich fuel combustion zone of the combustor to form rich fuel combustion product mixture, wherein the rich fuel combustion product mixture comprises NO at levels that are typically orders of magnitude above equilibrium levels. The elevated NO levels formed during the rich fuel combustion stage in the rich fuel combustion zone of the combustor to relax toward an equilibrium level during a relaxation stage in a relaxation zone of the fuel combustor, via an appropriately long residence time. According to this embodiment, following the relaxation stage, additional combustion air is delivered to the combustion product mixture with relaxed NO levels in a quench zone of the fuel combustor, whereby this reaction quench air sufficiently quickly stops or slows the combustion reaction. The mixture of the rich fuel combustion product mixture with relaxed NO levels and additional combustion air is delivered to a lean fuel combustion zone and further combusting of the combustion product mixture in a lean fuel combustion stage in the lean fuel combustion zone is conducted. The lean fuel combustion zone is of adequately short residence time to ensure minimal NOx formation from this zone.

According to certain illustrative embodiments, the ammonia combustor of the present disclosure comprises a dry ammonia combustor that does not require water or stream, or other diluent, to achieve low NOx emissions levels. For example, and without limitation, the presently disclosed dry ammonia fuel combustor achieves a level of 100 ppm or less of NOx emissions, depending upon combustor pressure and other variables. The combustor enables ammonia fuel combustion while achieving low NOx formation and emissions, without steam, water or diluent injection.

The combustor may be used in a wide variety of applications including, for example, electric power generation, aviation engines, marine propulsion, commercial heating, industrial heating, and residential heating.

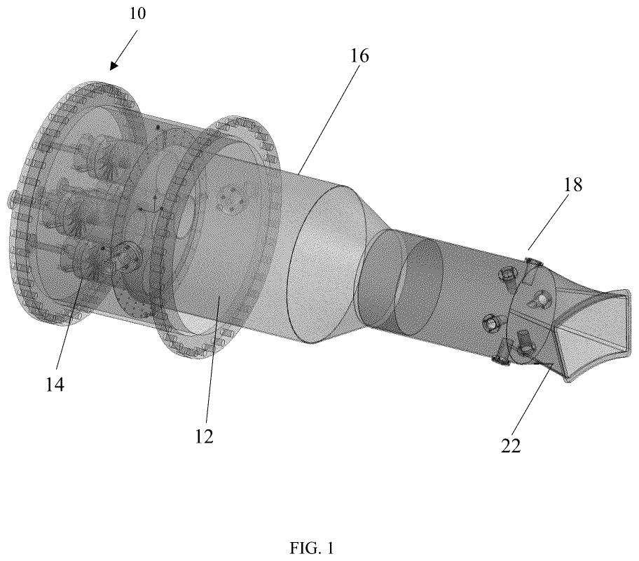

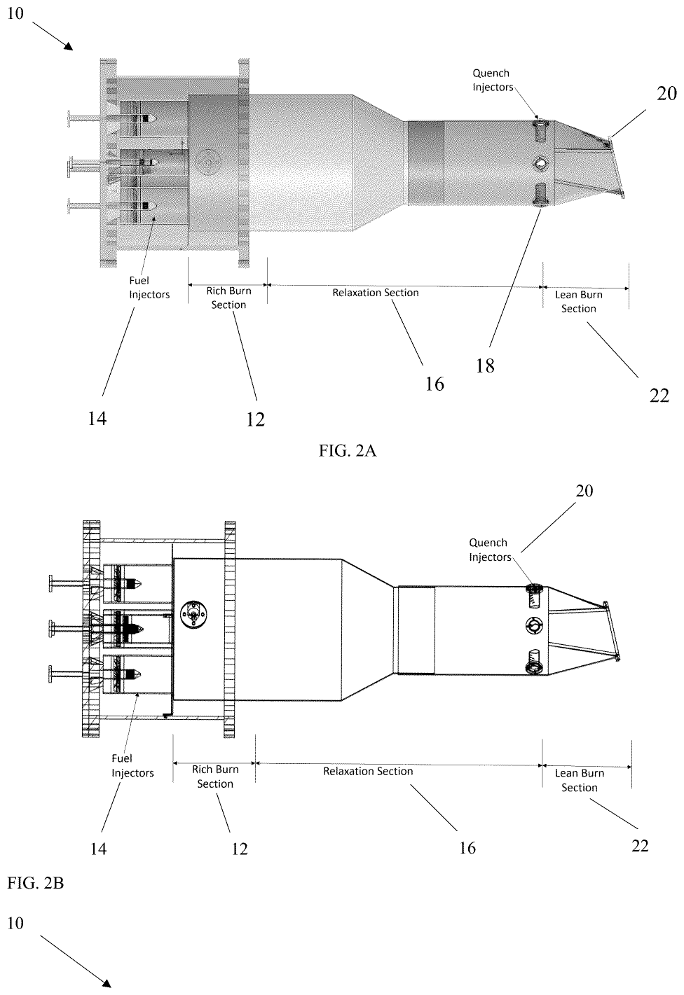

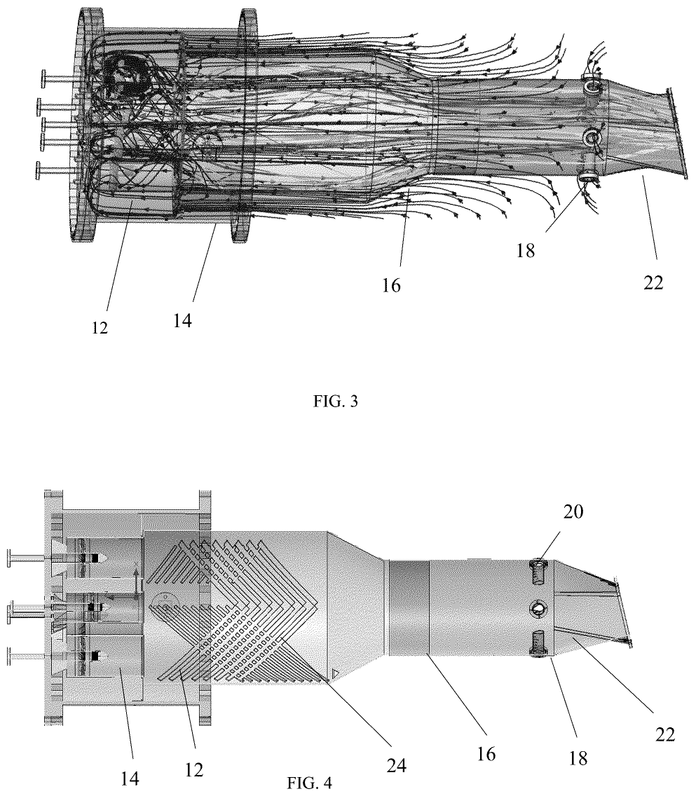

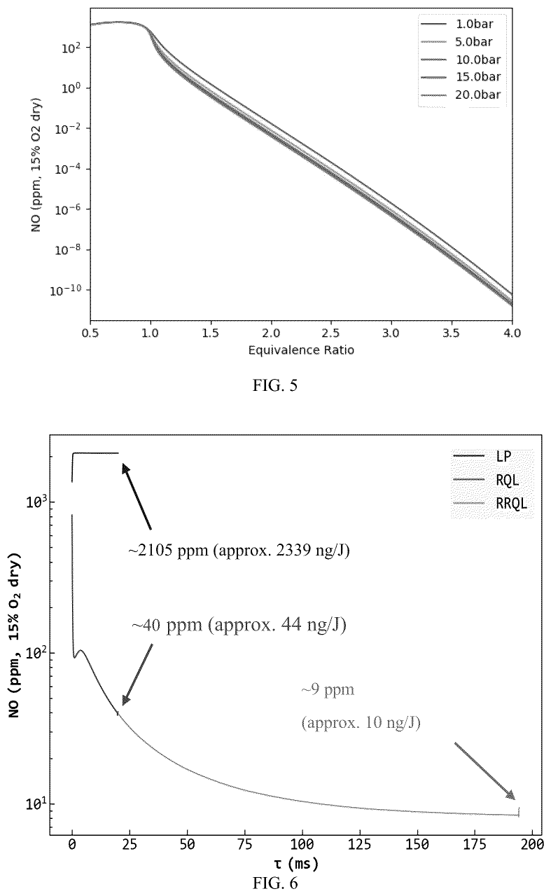

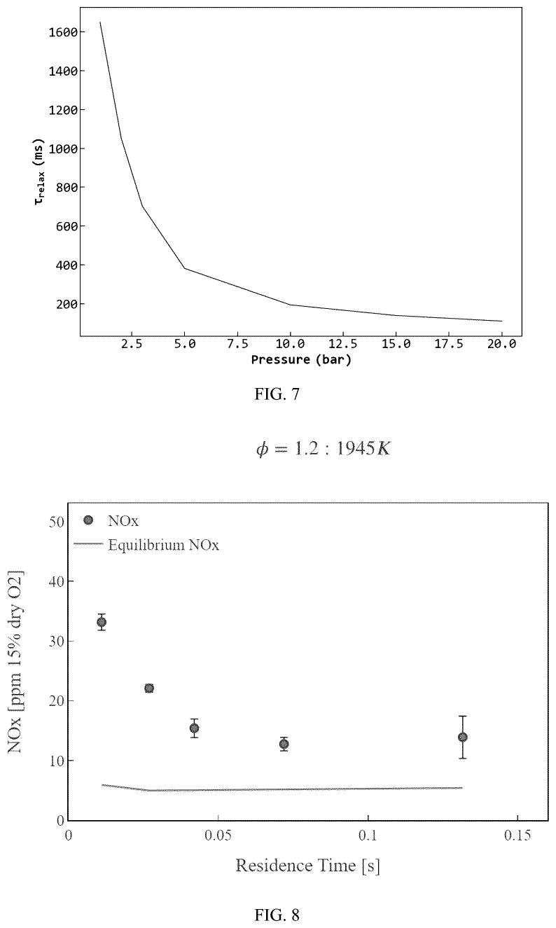

FIGS. 1-4 show illustrative embodiments of the presently disclosed fuel combustor. Fuel combustor 10 includes an upstream rich fuel stage 12 having at least one fuel injector 14 for injecting a nitrogen-containing fuel into the rich fuel stage 12. Downstream of rich fuel stage 12 is relaxation stage 16 for permitting peak NOx levels formed in the rich fuel stage 12 to approach or return to NOx equilibrium levels. Quench stage 18 is located downstream of relaxation stage 16 and is the stage where additional combustion air is introduced into the combustor via ports 20. The quench section may include an immersed “thimble” injector which will ensure the quench air performs well on the entirety of the reacting flow even for configurations with a low velocity through the quench ports. This design will also serve to ensure a well-mixed and low temperature peak temperature “profile” of the combustor exhaust. A high peak temperature profile is a problem for gas turbine hot gas path components downstream of the combustion system and late stage combustion air can exacerbate this issue. The thimble design shows improved temperature profile relative to other quench air designs. The quench air thimbles allow for good jet penetration and fast quenching of the reaction. This may be important for low velocity, low pressure drop combustors used for ammonia which may reduce the jet penetration capability of using only holes in the combustion liner or transition piece.

A secondary lean fuel stage 22 is located downstream from the quench stage 18 for further combustion of the rich fuel combustion product mixture having relaxed NOx levels and the additional combustion air added to the system in the quench stage 18. Referring to FIG. 4, the relaxation stage 16 includes a catalytic channel 24 for catalytically enhancing the chemical reactions during the relaxation stage 16 to permit the peak NOx levels from the rich fuel combustion stage to relax toward equilibrium levels.

FIG. 8 is a graph showing experimental measurements of NOx emissions for a rich ammonia air flame, at an equivalence ratio (ϕ) of 1.2 under atmospheric conditions with no preheat. NOx emissions reduce towards equilibrium with rich nitrogen-fuel combustion.

While the combustor, combustion turbine including the combustor, and method of combusting nitrogen-containing fuel with the combustor have been described in connection with various embodiments, it is to be understood that other similar embodiments may be used or modifications and additions may be made to the described embodiments for performing the same function. Furthermore, the various illustrative embodiments may be combined to produce the desired results. Therefore, the combustor, combustion turbine, uses of the combustor and combustion turbine, and methods of combusting nitrogen-containing fuels with the combustor should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A fuel combustor for a nitrogen-containing fuel comprising:
a rich fuel primary combustion zone;
a NOx relaxation zone downstream from said fuel rich primary combustion zone;
a combustion reaction quench zone downstream from said relaxation zone; and
a secondary lean fuel combustion zone downstream from said combustion reaction quench zone.

2. The fuel combustor of claim 1, wherein the NOx relaxation zone comprises conduit of sufficient length to provide a long residence time.

3. The fuel combustor of claim 1, wherein the NOx relaxation zone comprises a chemical reactor.

4. The fuel combustor of claim 3, wherein the chemical reactor comprises a catalytically enhanced chemical reactor.

5. The fuel combustor of claim 4, wherein said catalytically enhanced chemical reactor comprises a honeycomb catalyst support, plate-type catalyst support, or corrugated-type catalyst support with catalyst carried by said support.

6. The fuel combustor of claim 5, wherein said catalyst is selected from one or more of metal oxide-based, zeolite-based, alkaline-earth metal-based, and rare-earth-based catalysts.

7. The fuel combustor of claim 1, wherein said relaxation zone comprises at least one internal gas flow recirculation path.

8. A combustion turbine comprising a turbine and at least one fuel combustor of claim 1.

9. A method of combustion of nitrogen-containing fuel comprising:
delivering a nitrogen-containing fuel to a rich fuel combustion zone of a fuel combustor;
at least partially combusting the nitrogen-containing fuel in a rich fuel combustion stage in the rich fuel combustion zone of the combustor to form rich fuel a combustion product mixture, wherein the rich fuel combustion product mixture comprises NO at levels above equilibrium levels;
permitting NO levels formed during the rich fuel combustion stage in the rich fuel combustion zone of the combustor to relax toward an equilibrium level in a relaxation zone of the fuel combustor;
following the relaxation stage, delivering additional combustion air to the combustion product mixture in a quench zone of the fuel combustor;
delivering the mixture of the rich fuel combustion product mixture and additional combustion air to a lean fuel combustion zone; and
further combusting the rich fuel combustion product mixture in a lean fuel combustion stage in the lean fuel combustion zone.

10. The method of claim 9, wherein the nitrogen-containing fuel is ammonia fuel.

11. The method of claim 10, wherein the ammonia fuel and the combustion air are mixed prior to entering the rich fuel combustion stage.

12. The method of claim 10, wherein the ammonia fuel and the combustion air are not mixed prior to entering the rich fuel combustion stage.

13. The method of claim 10, wherein the ammonia fuel is mixed with the combustion air in the rich fuel combustion stage.

14. The method of claim 10, wherein the pressure of the rich fuel primary combustion stage is in the range of about 1 to about 40 bar, the temperature of the rich fuel primary combustion stage is in the range of about 1900 to about 2200 K, and the residence time of the rich fuel primary combustion stage is in the range of about 1 to about 5 ms.

15. The method of claim 14, wherein the residence time of the relaxation stage is about 20 to about 1000 ms.

16. The method of claim 15, wherein the pressure of the lean fuel secondary combustion stage is in the range of about 1 to about 40 bar, the temperature of the lean fuel secondary combustion stage is in the range of about 1600 to about 2050 K, and the residence time of the lean fuel secondary combustion stage is in the range of about 1 to about 20 ms.

17. A method of power generation comprising:
combusting a nitrogen-containing fuel in the fuel combustor of claim 1 to produce a combustion exhaust gas;
exhausting the combustion exhaust gas from the fuel combustor; and
driving a turbine with the combustion exhaust gas.

18. The method of claim 17, wherein the nitrogen-containing fuel is ammonia fuel.

19. The method of claim 17, wherein the ammonia fuel and the combustion air are mixed prior to entering the rich fuel combustion stage.

20. The method of claim 17, wherein the ammonia fuel and the combustion air are not mixed prior to entering the rich fuel combustion stage.
